(19) United States
(12) Patent Application Publication
(10) Pub. No.: US 2023/0167625 A1
(43) Pub. Date: Jun. 1, 2023

(54) HYDRAULIC WORK MACHINE AND REMOTE OPERATION SYSTEM

(71) Applicant: KOBELCO CONSTRUCTION MACHINERY CO., LTD., Hiroshima-shi, Hiroshima (JP)

(72) Inventors: Ryota HAMA, HIROSHIMA-SHI, HIROSHIMA (JP); Takayuki DOI, HIROSHIMA-SHI, HIROSHIMA (JP); Seiji SAIKI, HIROSHIMA-SHI, HIROSHIMA (JP)

(21) Appl. No.: 17/768,255

(22) PCT Filed: Aug. 31, 2020
(86) PCT No.: PCT/JP2020/032843

§ 371 Date: Apr. 12, 2022

(30) Foreign Application Priority Data
Nov. 1, 2019 (JP) 2019-199888

(51) Int. Cl. E02F 9/20; F15B 15/20; E02F 9/22; E02F 9/26

(52) U.S. Cl. CPC E02F 9/205; F15B 15/20; E02F 9/2285; E02F 9/267; E02F 9/2203

(57) ABSTRACT

A lever drive control unit 27a of a hydraulic work machine 10 performs actuation control on a lever drive actuator 21 so as to operate an operation lever 20 to a neutral position and operation positions for a maximum operation amount and stores control values for the lever drive actuator 21 at the respective operation positions, upon receipt of a request for execution of a process in a calibration mode. The lever drive control unit 27a uses the stored control values to create data prescribing a relation between a drive command for the operation lever 20 and a control value for the lever drive actuator 21.

### TECHNICAL FIELD

The present invention relates to a hydraulic work machine, such as a hydraulic shovel, and a remote manipulation system therefor.

### BACKGROUND ART

For example, Patent Literature 1 describes a technique for updating a set value such that the set value approaches an actual output value, in view of variation in output characteristics of an operation lever which is provided at a machine, such as a power shovel, if an output at the time of maximum operation of the operation lever is more than the set value.

### CITATION LIST

### Patent Literature

Patent Literature 1: Japanese Patent Laid-Open No. 6-313326

### SUMMARY OF INVENTION

### Technical Problem

The present inventors are promoting development of a system which performs remote manipulation of an operation lever (which may hereinafter be referred to as a first operation lever) of a hydraulic work machine, such as a hydraulic shovel. In this system, a lever drive actuator, such as an electric motor, which drives the first operation lever of the hydraulic work machine is mounted on the hydraulic work machine, and an operation lever (which may hereinafter be referred to as a second operation lever) for manipulation of the first operation lever of the hydraulic work machine is provided at a remote manipulation apparatus for performing remote manipulation of the hydraulic work machine. Remote manipulation of the first operation lever is performed by actuating the lever drive actuator in accordance with operation of the second operation lever.

In the above-described case, hydraulic work machines as objects of remote manipulation by a remote manipulation apparatus are not limited to particular hydraulic work machines and are desirably a plurality of models of hydraulic work machines. It is desired that it be possible to remotely manipulate a first operation lever of each hydraulic work machine in the same manner in accordance with operation of a second operation lever of the remote manipulation apparatus.

However, in the case, an operation amount of the first operation lever of each hydraulic work machine which is actually achieved in accordance with operation of the second operation lever of the remote manipulation apparatus may exceed or fall below an operation amount requested in accordance with operation of the second operation lever due to, e.g., variation in operating characteristics of a lever drive actuator or variation in an operation lever specification among hydraulic work machines.

For example, operation of a second operation lever to operate a first operation lever of a hydraulic work machine as a remote manipulation object to a neutral position may cause an inconvenient phenomenon in which an actual operation amount of the first operation lever deviates from an operation amount for the neutral position if the hydraulic work machine is a certain model of hydraulic work machine. Operation of the second operation lever to operate the first operation lever of the hydraulic work machine as the remote manipulation object in a certain direction by a maximum operation amount may cause an inconvenient phenomenon in which an actual operation amount of the first operation lever does not reach the maximum operation amount if the hydraulic work machine is a certain model of hydraulic work machine.

The present invention has been made against the above-described background, and has as an object to provide a hydraulic work machine having an operation lever to be remotely manipulated by an external manipulation apparatus via a lever drive actuator, the hydraulic work machine being capable of appropriately preventing an operation status of the operation lever which is achieved in accordance with operation of the manipulation apparatus from varying. The present invention has as another object to provide a remote manipulation system including the hydraulic work machine.

### Solution to Problem

In order to attain the above-described objects, a hydraulic work machine of the present invention is a hydraulic work machine including a hydraulic actuator, a first operation lever for operating the hydraulic actuator, a lever drive actuator which drives the first operation lever, and a lever drive control unit which is capable of receiving a drive command for operation of the first operation lever from an external manipulation apparatus and performs actuation control on the lever drive actuator in accordance with the drive command,

wherein the lever drive control unit

is capable of acquiring a detection value of an operation amount of the first operation lever detected by a first lever operation amount detector which is mounted on the hydraulic work machine so as to be capable of detecting the operation amount of the first operation lever and has a first calibration mode which is an operating mode for performing calibration related to remote manipulation of the first operation lever,

has a function of, when an execution command for a process in the first calibration mode is given, executing a first process of controlling the lever drive actuator so as to achieve a state satisfying a first condition that the detection value of the operation amount of the first operation lever falls within a predetermined range determined in advance for a neutral position of the first operation lever and storing and retaining a control value for the lever drive actuator in the state satisfying the first condition while actuation of the hydraulic actuator is prohibited, a second process of controlling the lever drive actuator so as to achieve a state satisfying a second condition that the detection value of the operation amount of the first operation lever coincides with a maximum operation amount for the first operation lever or a difference from the maximum operation amount falls within a predetermined range and storing and retaining a control value for the lever drive actuator in the state satisfying the second condition while actuation of the hydraulic actuator is prohibited, and a third process of determining data prescribing a relation between the drive command and a control value for controlling the lever drive actuator in accordance with the drive command on the basis of the control values stored and retained in the first process and the second process, respectively, and storing and retaining the data and is configured to determine the data in the third process such that the control value prescribed in the data coincides with the control value stored in the first process if the drive command is a drive command giving a command for operation of the first operation lever to the neutral position and such that the control value prescribed in the data coincides with the control value stored in the second process if the drive command is a drive command giving a command for operation of the first operation lever to the maximum operation amount for the first operation lever, and is configured to, at the time of actuation of the lever drive actuator in accordance with a drive command received from the manipulation apparatus after execution of the third process, perform actuation control on the lever drive actuator with the control value determined from the received drive command on the basis of the data stored and retained in the third process.

A remote manipulation system of the present invention includes a hydraulic work machine of the present invention having the above-described configuration and the manipulation apparatus.

### BRIEF DESCRIPTION OF DRAWINGS

FIG. 1 is a chart showing an overall configuration of a remote manipulation system according to an embodiment of the present invention.

FIG. 2 is a block diagram showing a configuration related to a process of controlling the remote manipulation system in FIG. 1.

FIG. 3 is a view schematically showing a mechanistic configuration of a remote manipulation apparatus of the remote manipulation system in FIG. 1.

FIG. 4 is a flowchart showing a process in a first embodiment by a slave-side control device shown in FIG. 2.

FIG. 5 is a flowchart showing a process in the first embodiment by a master-side control device shown in FIG. 2.

FIG. 6 is a chart showing, as an example, a graph related to relational data which is created by the process in FIG. 4.

FIG. 7 is a chart showing, as an example, a graph related to relational data which is created by the process in FIG. 5.

FIG. 8 is a flowchart showing a process in a second embodiment by the slave-side control device shown in FIG. 2.

### DESCRIPTION OF EMBODIMENTS

### First Embodiment

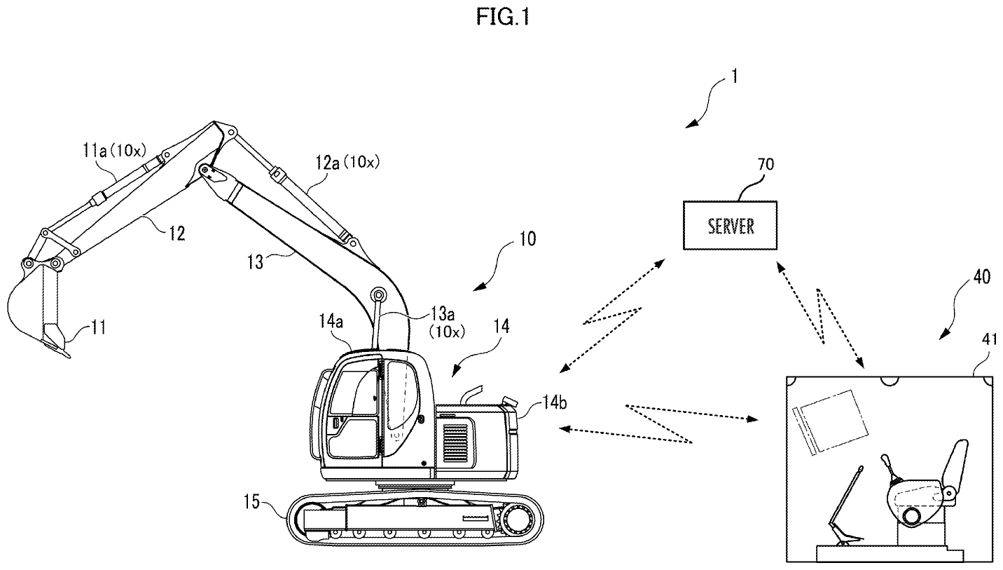

A first embodiment of the present invention will be described below with reference to FIGS. 1 to 7. The present embodiment is, for example, an embodiment in which a hydraulic work machine 10 (hereinafter simply referred to as the work machine 10) is applied to a remote manipulation system 1 which is configured so as to be remotely manipulatable by an operator (manipulator) using a remote manipulation apparatus 40. In the present embodiment, a server 70 which is capable of various management processes of the remote manipulation system 1, information collection, and the like is included in the remote manipulation system 1, in addition to the work machine 10 and the remote manipulation apparatus 40.

The work machine 10 is, for example, a hydraulic shovel and includes an attachment 11, an arm 12, a boom 13, a slewing structure 14, and carriers 15. The carriers 15 are one pair of left and right crawler-type carriers in the shown example, and each of the left and right carriers 15 is driven by a traveling hydraulic motor (not shown). Note that the carriers 15 may be wheel-type carriers.

The slewing structure 14 is arranged on an upper side of the carriers 15 and is configured to be capable of slewing in a yaw direction (a direction about an axis of a vertical direction) with respect to the carriers 15 by a slewing hydraulic motor (not shown). A machine room 14b in which hydraulic equipment (not shown) (e.g., a hydraulic pump, a directional control valve, and a hydraulic oil tank) and an engine (not shown) serving as a power source of the hydraulic pump and the like are housed is provided at a rear portion of the slewing structure 14.

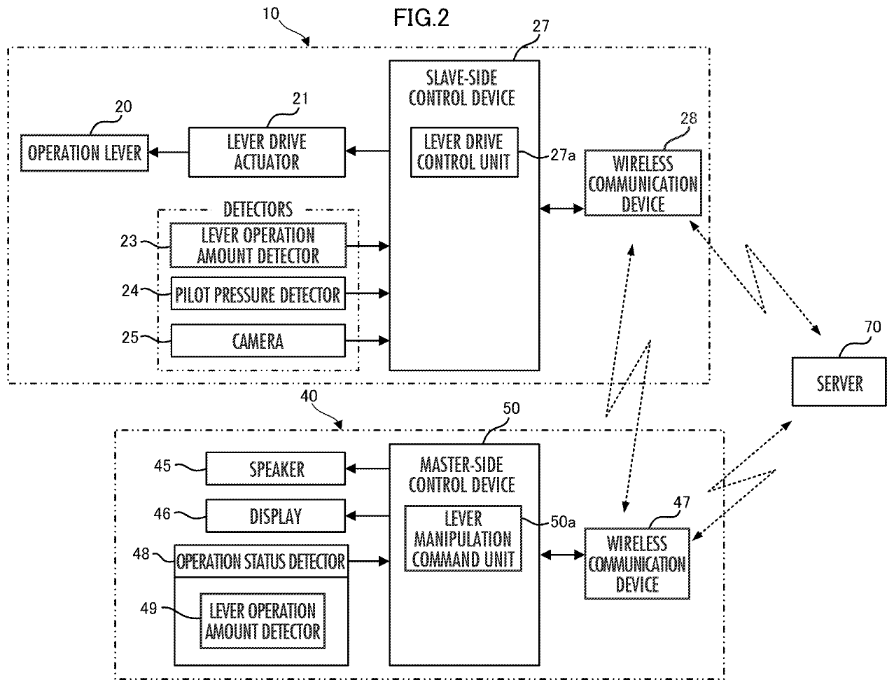

The work machine 10 is a work machine which an operator can get on and manipulate. An operator's cabin 14a is provided at a front portion of the slewing structure 14. Although not shown in detail, an operation device which includes a plurality of operation levers 20 (shown in FIG. 2) for manipulation of the work machine 10 on two left and right sides and front side of an operator's seat is arranged in the operator's cabin 14a. The operation device can include an operation switch and the like in addition to the operation levers 20.

The boom 13 is attached to the front portion of the slewing structure 14 so as to be swingable with respect to the slewing structure 14 by a hydraulic cylinder 13a. The arm 12 is attached to a distal end portion of the boom 13 so as to be swingable with respect to the boom 13 by a hydraulic cylinder 12a. The attachment 11 is attached to a distal end portion of the arm 12 so as to be swingable with respect to the arm 12 by a hydraulic cylinder 11a. Although a bucket is shown as an example of the attachment 11 in FIG. 1, the attachment 11 may be another type of attachment (e.g., a crusher, a breaker, or a magnet).

As a supplementary explanation, the traveling hydraulic motors, the slewing hydraulic motor, and the hydraulic cylinders 11a, 12a, and 13a described above each correspond to a hydraulic actuator according to the present invention. Hereinafter, the components are generically called hydraulic actuators 10x. Note that hydraulic actuators 10x which are provided in the work machine 10 are not limited to the traveling hydraulic motors, the slewing hydraulic motor, and the hydraulic cylinders 11a, 12a, and 13a described above and can further include another hydraulic actuator (e.g., a hydraulic actuator for driving of a dozer or a hydraulic actuator included in an attachment of a crusher or the like).

In the work machine 10 with the above-described configuration, operating the operation levers 20 with the engine actuated allows actuation of the hydraulic actuators 10x, such as the traveling hydraulic motors, the slewing hydraulic motor, and the hydraulic cylinders 11a, 12a, and 13a, which in turn allows manipulation of the work machine 10. In this case, actuation of each hydraulic actuator 10x commensurate with operation of the operation lever 20 can be performed in the same manner as in a publicly known work machine.

For example, by performing swing operation (swing operation in a longitudinal direction or a lateral direction) of the operation lever 20 for manipulation of each hydraulic actuator 10x, a directional control valve (not shown) corresponding to the hydraulic actuator 10x is driven by a pilot pressure which is given in accordance with an operation amount and an operation direction of the operation lever 20. Hydraulic oil is supplied accordingly from the hydraulic pump (not shown) to the hydraulic actuator 10x via the directional control valve, and the hydraulic actuator 10x is actuated. At this time, the amount of the hydraulic oil supplied to the hydraulic actuator 10x is controlled in accordance with the operation amount of the operation lever 20. An actuation direction of the hydraulic actuator 10x is controlled in accordance with the operation direction of the operation lever 20.

In the present embodiment, to allow remote manipulation of the work machine 10 as a slave, a motorized lever drive actuator 21 which drives the operation lever 20 is mounted on the work machine 10, as shown in FIG. 2. In this case, the lever drive actuator 21 is composed of, for example, an electric motor and is provided for each hydraulic actuator 10x of the work machine 10. Note that a combination of one lever drive actuator 21 and one operation lever 20 as an object to be driven thereby is shown as a representative in FIG. 2 for convenience.

Each lever drive actuator 21 is connected to the operation lever 20 for manipulation of the corresponding hydraulic actuator 10x via an appropriate power transmission mechanism such that the lever drive actuator 21 can swing the operation lever 20. For example, if a certain hydraulic actuator 10x of the work machine 10 is configured to be capable of being actuated by swing operation of the operation lever 20 for manipulation of the hydraulic actuator 10x in the longitudinal direction (or the lateral direction), the lever drive actuator 21 corresponding to the hydraulic actuator 10x is connected to the operation lever 20 via a power transmission mechanism including a speed reducer and the like such that the lever drive actuator 21 can swing the operation lever 20 for manipulation of the hydraulic actuator 10x in the longitudinal direction (or the lateral direction). The same applies to the lever drive actuators 21 corresponding to the other hydraulic actuators 10x of the work machine 10.

Note that the lever drive actuator 21 and the power transmission mechanism can be configured to be removable from the work machine 10 if remote manipulation of the work machine 10 is not performed. The operation lever 20 that drives the lever drive actuator 21 is not limited to one which is configured to be capable of manual operation and may be one, such as an operation pedal, which an operator can operate with a foot.

Various detectors for detecting a manipulation status or an actuation status of the work machine 10, an outside world status, or the like, a slave-side control device 27 which is capable of executing various control processes related to the work machine 10, and a wireless communication device 28 for performing communication with the remote manipulation apparatus 40 or the server 70 are further mounted on the work machine 10, as shown in FIG. 2.

In the present embodiment, the detectors of the work machine 10 include, for example, a lever operation amount detector 23 which detects an operation amount (a swing angle in the present embodiment) of each operation lever 20, a pilot pressure detector 24 which is a pressure detector detecting a pilot pressure given to the directional control valve corresponding to the hydraulic actuator 10x as a manipulation object in accordance with operation of the operation lever 20, and a camera 25 which is mounted on the work machine 10 so as to be capable of shooting the front of the operator's cabin 14a of the work machine 10 and surroundings of the slewing structure 14. In this case, the lever operation amount detector 23 is composed of, for example, a potentiometer and outputs a detection signal commensurate with the swing angle of the operation lever 20.

The slave-side control device 27 is composed of, for example, one or more electronic circuit units including a microcomputer, a memory, an interface circuit, and the like, and detection signals from the detectors (including the lever operation amount detector 23, the pilot pressure detector 24, and the camera 25) of the work machine 10 are input to the slave-side control device 27. The slave-side control device 27 is also capable of performing communication with a master-side control device 50 (to be described later) of the remote manipulation apparatus 40 or the server 70 via the wireless communication device 28 on an as-needed basis.

The slave-side control device 27 can perform various types of operation control on the work machine 10 by functions which are implemented by both or one of a hardware component and a program (software component) which are mounted. In this case, the slave-side control device 27 includes a function of a lever drive control unit 27a which performs actuation control on each lever drive actuator 21.

As a supplementary explanation, in the present embodiment, the operation lever 20 of the work machine 10 corresponds to a first operation lever according to the present invention, and the lever operation amount detector 23 corresponds to a first lever operation amount detector according to the present invention.

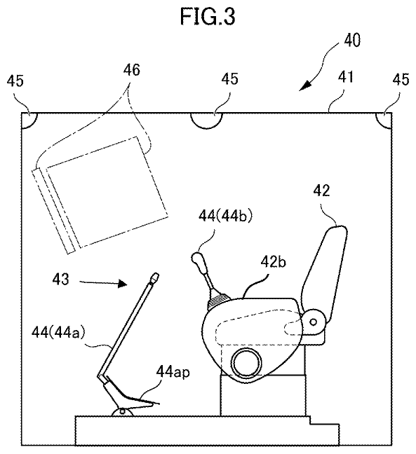

The remote manipulation apparatus 40 will be described. The remote manipulation apparatus 40 corresponds to a manipulation apparatus according to the present invention. The remote manipulation apparatus 40 includes, in a manipulation room 41, a seat 42 on which an operator (not shown) sits, an operation device 43 which the operator operates for remote manipulation of the work machine 10, a speaker 45 as an output device for acoustic information (audio information), such as voice or an alarm tone, and a display 46 as an output device for display information (visual information), as shown in FIG. 3.

As shown in FIG. 2, the remote manipulation apparatus 40 includes a wireless communication device 47 for performing wireless communication with the slave-side control device 27 of the work machine 10 or the server 70, an operation status detector 48 for detecting an operation status of the operation device 43, and the master-side control device 50 which is capable of executing various control processes related to the remote manipulation apparatus 40. Note that the wireless communication device 47 and the master-side control device 50 may be arranged either inside or outside the manipulation room 41.

As the operation device 43, for example, one with a configuration which is the same as or similar to that of the operation device of the work machine 10 can be adopted. For example, the operation device 43 has a plurality of operation levers 44 including an operation lever 44a with an operation pedal 44ap which is installed on a front side of the seat 42 such that the operator seated on the seat 42 can operate the operation lever 44a and respective operation levers 44b which are mounted on left and right consoles 42b of the seat 42 and has a plurality of operation switches (not shown) and the like, as shown as an example in FIG. 3. Note that the operation device 43 may be one with a configuration different from that of the operation device of the work machine 10. For example, the operation device 43 may be a portable-type operation device having a joystick, an operation button, and the like.

The operation status detector 48 includes a lever operation amount detector 49 which detects an operation amount (a swing angle in the present embodiment) of each operation lever 44 in the present embodiment. The lever operation amount detector 49 is composed of, for example, a potentiometer and outputs a detection signal commensurate with the swing angle of the operation lever 44. Note that although not shown, the operation status detector 48 can include, e.g., a sensor which detects operation statuses of the operation switches included in the operation device 43, in addition to the lever operation amount detector 49. As a supplementary explanation, in the present embodiment, the operation lever 44 corresponds to a second operation lever according to the present invention, and the lever operation amount detector 49 corresponds to a second lever operation amount detector according to the present invention.

Speakers 45 are arranged at a plurality of spots in the manipulation room 41. The display 46 is composed of, for example, a liquid crystal display or a head-up display and is arranged on the front side of the seat 42 such that the operator seated on the seat 42 can visually recognize the display 46.

The master-side control device 50 is composed of, for example, one or more electronic circuit units including a microcomputer, a memory, an interface circuit, and the like, and a detection signal from the operation status detector 48 is input to the master-side control device 50. The master-side control device 50 is also capable of performing communication with the slave-side control device 27 of the work machine 10 or the server 70 via the wireless communication device 47 on an as-needed basis. In this case, the master-side control device 50 is capable of performing selective communication connection to the slave-side control device 27 of each of a plurality of work machines 10.

The master-side control device 50 is capable of transmitting a prescribed operation command or the like for the work machine 10 in accordance with the operation status of the operation device 43 that is detected by the operation status detector 48 to the slave-side control device 27. Alternatively, the master-side control device 50 is capable of receiving various information (e.g., a video shot by the camera 25 and detection information of an operating status of the work machine 10) on the work machine 10 side from the slave-side control device 27.

In the above-described case, the master-side control device 50 includes, as a function which is implemented by both or one of a hardware component and a program (software component) which are mounted, a function of a lever manipulation command unit 50a which is capable of executing a process of generating a drive command (to be described later in detail) for operating the operation lever 20 of the work machine 10 and transmitting the drive command to the slave-side control device 27 in accordance with operation of the operation lever 44 at the time of remote manipulation of the work machine 10. The master-side control device 50 further has a function of controlling output by the speakers 45 and display by the display 46.

The server 70 is composed of, for example, a computer. The server 70 is capable of communicating with slave-side control devices 27 of a plurality of work machines 10 and master-side control devices 50 of a plurality of remote manipulation apparatuses 40. The server 70 has a function of collecting various information, such as a working status of each work machine 10 or each remote manipulation apparatus 40, from the control device 27 or 50 therefor, a function of storing and retaining use history information of each work machine 10 or each remote manipulation apparatus 40, a function of transmitting various command information and the like to the slave-side control device 27 of each work machine 10 or the master-side control device 50 of each remote manipulation apparatus 40, and the like. Planned use information of each work machine 10 or each remote manipulation apparatus 40 and the like can be registered in the server 70. As a supplementary explanation, the server 70 is a server having a combination of a function of a first server according to the present invention and a function of a second server.

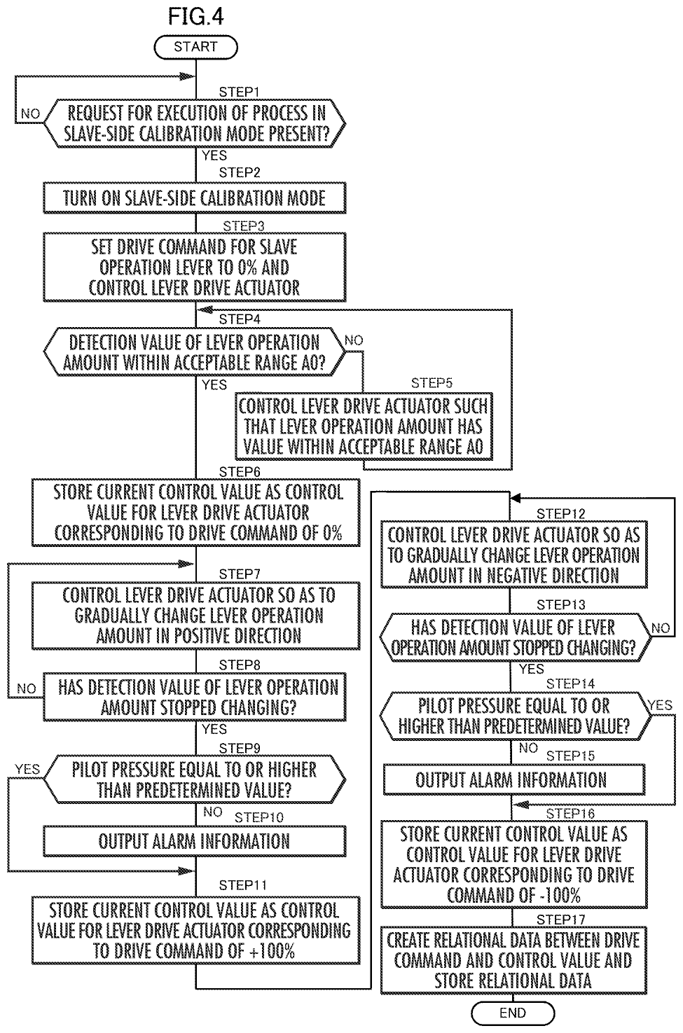

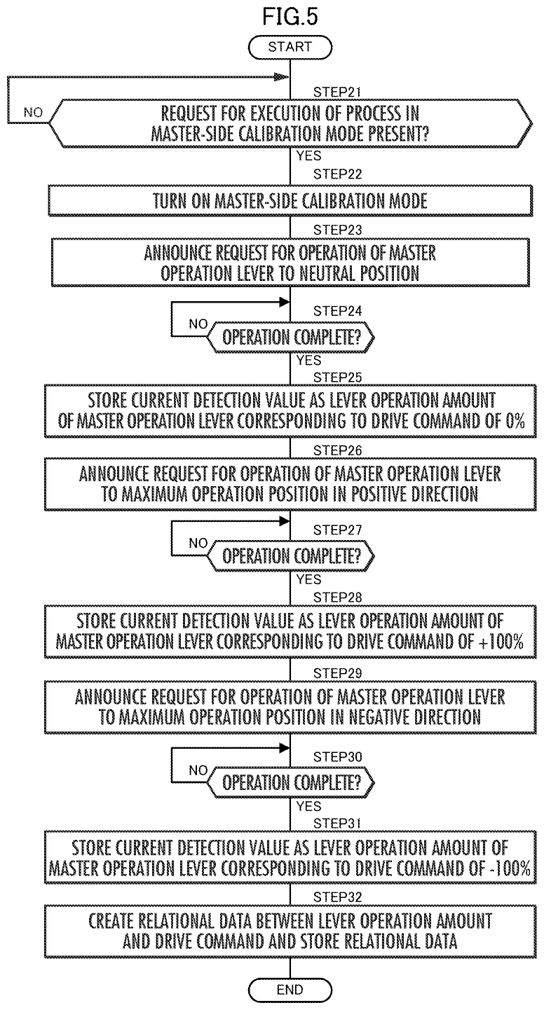

A calibration process (calibration) related to operation (operation through remote manipulation) of the operation lever 20 (which may hereinafter be referred to as the slave operation lever 20) of the work machine 10 and a calibration process (calibration) related to operation of the operation lever 44 of the remote manipulation apparatus 40 will be described with reference to FIGS. 4 and 5.

In the present embodiment, at the time of remote manipulation of the work machine 10 by the remote manipulation apparatus 40, the master-side control device 50 executes, by means of the lever manipulation command unit 50a, a process of transmitting a drive command for operation of the slave operation lever 20 which is generated in accordance with a detection value of an operation amount (which includes an operation direction and may hereinafter be referred to as a lever operation amount) of each master operation lever 44 which is detected by the lever operation amount detector 23 to the slave-side control device 27 of the work machine 10 as a remote manipulation object while sequentially acquiring the detection value of the lever operation amount.

The drive command is a command value which gives a command for an operation direction and an operation amount of each slave operation lever 20 of the work machine 10 as the remote manipulation object. In the present embodiment, the drive command is generated as a command value which is normalized between a neutral position as an operation position of the slave operation lever 20 in a case where the hydraulic actuator 10x corresponding to the slave operation lever 20 is not actuated and maximum operation positions of the slave operation lever 20 in respective operation directions which are a positive direction and a negative direction.

For example, a drive command for operating the slave operation lever 20 to the neutral position is defined as 0%, a drive command for operating the slave operation lever 20 from the neutral position to an operation position obtained when the slave operation lever 20 is displaced in the positive direction by a maximum operation amount is defined as +100%, and a drive command for operating the slave operation lever 20 to an operation position obtained when the slave operation lever 20 is displaced in the negative direction by the maximum operation amount is defined as −100%. A drive command when the slave operation lever 20 is operated from the neutral position in the positive direction is determined so as to vary linearly with a change in a lever operation amount (swing angle) from a neutral position of the master operation lever 44 between 0% and +100%.

A drive command when the slave operation lever 20 is operated from the neutral position in the negative direction is determined so as to vary linearly with a change in an operation amount (swing angle) from the neutral position of the master operation lever 44 between 0% and −100%. In this case, the drive command is determined from a detection value of a lever operation amount of the master operation lever 44 which is detected by the lever operation amount detector 49 of the remote manipulation apparatus 40, on the basis of predetermined relational data (data prescribing a relation between a lever operation amount of the master operation lever 44 and a drive command).

Note that the positive direction and the negative direction that are operation directions of the slave operation lever 20 mean directions opposite to each other in the description of the present embodiment. For example, the positive direction and the negative direction that are operation directions of the slave operation lever 20 that is swingably operated in the longitudinal direction mean a forward direction and a backward direction ((or the backward direction and the forward direction), respectively. The same applies to an operation direction of the master operation lever 44.

The slave-side control device 27 of the work machine 10 as the remote manipulation object performs actuation control on the lever drive actuator 21 by means of the lever drive control unit 27a, in accordance with a drive command which is received from the master-side control device 50. Specifically, the lever drive control unit 27a determines a control value (e.g., a control value designating a rotation amount of an output shaft of the lever drive actuator 21 or a swing rotation amount of the slave operation lever 20) for actuating the lever drive actuator 21 that drives the slave operation lever 20 as an operation object from the drive command received from the master-side control device 50 on the basis of predetermined relational data (data prescribing a relation between a drive command and a control value). The lever drive control unit 27a performs actuation control (feedforward control) on the lever drive actuator 21 in accordance with the control value.

The calibration process related to operation of the slave operation lever 20 of the work machine 10 is a process of calibrating relational data prescribing a relation between a drive command which corresponds to each hydraulic actuator 10x of the work machine 10 and is given to the slave-side control device 27 and a control value for the lever drive actuator 21 that drives the slave operation lever 20 for manipulation of each hydraulic actuator 10x. The calibration process is executed by the lever drive control unit 27a of the slave-side control device 27 in a manner as indicated by the flowchart in FIG. 4.

In STEP1, the lever drive control unit 27a of the slave-side control device 27 sequentially repeats judging whether there is a request for execution of a process in a slave-side calibration mode until a result of the judgment is affirmative. At this time, a command indicating a request for execution of the process in the slave-side calibration mode is transmitted from the server 70 or the master-side control device 50 of the remote manipulation apparatus 40 to the slave-side control device 27 on an as-needed basis while work by the work machine 10 is under suspension.

For example, the server 70 transmits a command indicating a request for execution of the process in the slave-side calibration mode to the slave-side control device 27 at a timing which is determined on the basis of work history information, planned work information, and the like of the work machine 10. Specifically, the server 70 transmits the command indicating the request for execution of the process in the slave-side calibration mode to the slave-side control device 27, for example, when a cumulative work time period of the work machine 10 reaches a predetermined time period, when the number of times work from the start of operation of the work machine 10 to the end of the operation is performed reaches a predetermined number, or at a timing before the start of one-day work using the work machine 10 or a timing after the end.

Alternatively, for example, an operator which performs remote manipulation of the work machine 10 performs predetermined operation of the operation device 43 of the remote manipulation apparatus 40 when the operator is about to start remote manipulation of the work machine 10, thereby transmitting a command indicating a request for execution of the process in the slave-side calibration mode from the master-side control device 50 to the slave-side control device 27.

Note that it is also possible for the server 70 or the master-side control device 50 to transmit a command indicating a request for execution of the process in the slave-side calibration mode to each of a plurality of work machines 10. A command for a request for execution of the process in the slave-side calibration mode may be given to the slave-side control device 27 by a given worker performing predetermined operation at the work machine 10.

When the result of the judgment in STEP1 is affirmative, the lever drive control unit 27a enters (turns on) the slave-side calibration mode as one of operating modes of the slave-side control device 27 in STEP2. The slave-side calibration mode corresponds to a first calibration mode according to the present invention. The lever drive control unit 27a executes processes starting from STEP3 as the process in the slave-side calibration mode.

As a supplementary explanation, the processes starting from STEP3 is a process to be performed for each of the operation levers 20 for manipulation of the respective hydraulic actuators 10x of the work machine 10, to be more specific. Note that only processes related to the operation lever 20 corresponding to one hydraulic actuator 10x are illustrated as a representative in FIG. 4.

The process in the slave-side calibration mode is performed while actuation of each hydraulic actuator 10x of the work machine 10 is prohibited. In this case, the lever drive control unit 27a inhibits hydraulic oil from being supplied to each hydraulic actuator 10x by, for example, controlling an unloading valve so as to open an exhaust port of the hydraulic pump that supplies hydraulic oil to each hydraulic actuator 10x to the hydraulic oil tank via the unloading valve.

Alternatively, hydraulic oil is inhibited from being supplied to each hydraulic actuator 10x by, for example, providing a shutoff valve capable of opening and closing an oil passage which supplies hydraulic oil from the exhaust port to the directional control valves and connecting a relief valve to an oil passage between the shutoff valve and the exhaust port of the hydraulic pump so as to return hydraulic oil from the hydraulic pump to the hydraulic oil tank via the relief valve in a state where the shutoff valve is controlled to be closed. This prohibits actuation of each hydraulic actuator 10x.

In STEP3, the lever drive control unit 27a sets a drive command for the slave operation lever 20 to 0% (a drive command for operation to the neutral position) and controls the lever drive actuator 21 in accordance with the drive command. In this case, relational data indicating a relation between a drive command for the slave operation lever 20 and a control value (a control value designating a rotation amount of the output shaft of the lever drive actuator 21 or a swing rotation amount of the slave operation lever 20 in the present embodiment) for the lever drive actuator 21 is stored and retained in the slave-side control device 27.

The relational data is data created by the process in the slave-side calibration mode on the previous occasion or default data stored and retained in advance in the slave-side control device 27. The lever drive control unit 27a determines a control value for the lever drive actuator 21 corresponding to the drive command of 0% on the basis of the relational data and actuates the lever drive actuator 21 with the control value.

In STEP4, the lever drive control unit 27a acquires a detection value of a lever operation amount (swing angle) of the slave operation lever 20 obtained by the lever operation amount detector 23 and judges whether the detection value falls within a predetermined acceptable range A0. The acceptable range A0 is a range which is determined in advance as a proper range for a lever operation amount which is detected for the neutral position of the slave operation lever 20 by the lever operation amount detector 23. Note that the acceptable range A0 is set in advance, for example, for each of models of the work machines 10 or for each individual work machine 10.

If a result of the judgment in STEP4 is negative, the lever drive control unit 27a controls the lever drive actuator 21 such that the lever operation amount of the slave operation lever 20 has a value within the acceptable range A0 in S PEPS and further executes the judgment process in STEP4 again.

In STEP5, the lever drive control unit 27a, for example, updates the control value for the lever drive actuator 21 by a predetermined amount such that the lever operation amount of the slave operation lever 20 is closer to within the acceptable range A0 and actuates the lever drive actuator 21 in accordance with the updated control value.

Alternatively, the lever drive control unit 27a updates the control value for the lever drive actuator 21 by a correction amount which is determined in accordance with a deviation of a detection value of the lever operation amount of the slave operation lever 20 from a representative value (e.g., a value of one closer to the detection value of the lever operation amount of an upper limit and a lower limit of the acceptable range A0 or a median value of the acceptable range A0) of the acceptable range A0 and actuates the lever drive actuator 21 with the updated control value.

If the result of the judgment in STEP4 is affirmative, the lever drive control unit 27a stores and retains a current control value (a control value at a time point of judgement of the result of the judgment in STEP4 as affirmative) as the control value for the lever drive actuator 21 corresponding to the drive command of 0% in STEP6.

In STEP7, the lever drive control unit 27a executes a process of controlling the lever drive actuator 21 so as to gradually increase the lever operation amount of the slave operation lever 20 in the positive direction until a result of judgment in STEP8 is affirmative. In this case, in STEP7, the lever drive control unit 27a, for example, updates the control value for the lever drive actuator 21 in small steps (e.g., at intervals of predetermined time periods) so as to gradually increase the lever operation amount of the slave operation lever 20 in the positive direction by a predetermined amount at a time and actuates the lever drive actuator 21 with the updated control value after each update.

In STEP8, the lever drive control unit 27a judges whether a detection value of the lever operation amount of the slave operation lever 20 has stopped changing in the positive direction while sequentially acquiring the detection value of the lever operation amount.

Here, the slave operation lever 20 allows swing operation within a movable range which is mechanistically prescribed. If the slave operation lever 20 is operated to a limit (a mechanistic maximum operation amount in the positive direction) for the positive direction of the movable range by the process in STEP7, a result of the judgment in STEP8 changes from negative to affirmative.

When the result of the judgment in STEP8 changes from negative to affirmative, the lever drive control unit 27a ends actuation control on the lever drive actuator 21 by the process in STEP7 and executes a judgment process in STEP9. In STEP9, the lever drive control unit 27a acquires a detection value of a current pilot pressure (a pilot pressure which is given to the directional control valve corresponding to the hydraulic actuator 10x as a manipulation object by operation of the slave operation lever 20 in STEP7, to be more specific) which is detected by the pilot pressure detector 24 and judges whether the detection value of the pilot pressure has risen to a pressure equal to or higher than a predetermined value.

In the above-described case, the predetermined value for the pilot pressure is a value which is set in advance for each of the models of the work machines 10 or for each individual work machine 10 as a proper pilot pressure to be given to the hydraulic actuator 10x as the manipulation object when the slave operation lever 20 is operated in the positive direction by the maximum operation amount.

If a result of the judgment in STEP9 is negative, the lever drive control unit 27a outputs (transmits) alarm information stating that an actuation speed of the hydraulic actuator 10x as the manipulation object may be insufficient even if the slave operation lever 20 is operated in the positive direction by the maximum operation amount to both or one of the server 70 and the master-side control device 50 in STEP10.

The alarm information is announced from the server 70 or the master-side control device 50 to an operator at the time of, for example, actual manipulation of the work machine 10 with the remote manipulation apparatus 40. The announcement can be made via, for example, both or one of the speaker 45 and the display 46 of the remote manipulation apparatus 40 or a portable terminal carried by the operator.

If the result of the judgment in STEP9 is affirmative or if the process in STEP10 above is executed, the lever drive control unit 27a stores and retains the current control value (a control value at a time point of judgement of the result of the judgment in STEP8 as affirmative) as a control value for the lever drive actuator 21 corresponding to a drive command of +100% in STEP11.

In STEP12, the lever drive control unit 27a returns the slave operation lever 20 to the neutral position, and executes a process of controlling the lever drive actuator 21 so as to gradually increase the lever operation amount (swing angle) in the negative direction until a result of judgment in STEP13 is affirmative.

In the above-described case, the process in STEP12 is performed in the same manner as in STEP7 described earlier. In STEP13, the lever drive control unit 27a judges whether a detection value of the lever operation amount of the slave operation lever 20 has stopped changing in the negative direction while sequentially acquiring the detection value of the lever operation amount.

Here, if the slave operation lever 20 is operated to a limit (a mechanistic maximum operation amount in the negative direction) for the negative direction of the movable range by the process in STEP12, a result of the judgment in STEP13 changes from negative to affirmative.

When the result of the judgment in STEP13 changes from negative to affirmative, the lever drive control unit 27a ends actuation control on the lever drive actuator 21 by the process in STEP12 and executes a judgment process in STEP14. In STEP14, whether a detection value of the pilot pressure given to the directional control valve corresponding to the hydraulic actuator 10x as the manipulation object by operation of the slave operation lever 20 in STEP12 has risen to a pressure equal to or higher than a predetermined value is judged, as in STEP9 described earlier.

In the above-described case, the predetermined value for the pilot pressure is a value which is set in advance for each of the models of the work machines 10 or for each individual work machine 10 as a proper pilot pressure to be given to the hydraulic actuator 10x as the manipulation object when the slave operation lever 20 is operated by the maximum operation amount in the negative direction.

If a result of the judgment in STEP14 is negative, the lever drive control unit 27a outputs (transmits) alarm information stating that the actuation speed of the hydraulic actuator 10x as the manipulation object may be insufficient even if the slave operation lever 20 is operated in the negative direction by the maximum operation amount to both or one of the server 70 and the master-side control device 50 in STEP15. The alarm information is announced from the server 70 or the master-side control device 50 to the operator at the time of, for example, actual manipulation of the work machine 10 with the remote manipulation apparatus 40, like the alarm information in STEP10.

If the result of the judgment in STEP14 is affirmative or if the process in STEP15 above is executed, the lever drive control unit 27a stores and retains the current control value (a control value at a time point of judgement of the result of the judgment in STEP13 as affirmative) as a control value for the lever drive actuator 21 corresponding to a drive command of −100% in STEP16.

In STEP17, the lever drive control unit 27a creates relational data prescribing a relation between a drive command and a control value for the lever drive actuator 21 and stores and retains the relational data. The relational data is expressed in the form of, for example, an arithmetic expression or a map.

In the above-described case, relational data prescribing a relation between a drive command and a control value is newly created using, as constraints, the control value corresponding to the drive command of 0%, the control value corresponding to the drive command of +100%, and the control value corresponding to the drive command of −100% that are stored in STEP6, STEP11, and STEP16, respectively, such that a lever operation amount (swing angle) of the slave operation lever 20 which is obtained by actuating the lever drive actuator 21 in accordance with a control value changes linearly with a drive command within a drive command range from 0% to +100% and within a drive command range from 0% to −100% and is stored and retained.

In the case, the relational data is created such that a control value prescribed by the new relational data so as to correspond to the drive command of 0% coincides with the control value stored in STEP6, such that a control value prescribed by the new relational data so as to correspond to the drive command of +100% coincides with the control value stored in STEP11, and such that a control value prescribed by the new relational data so as to correspond to the drive command of −100% coincides with the control value stored in STEP16.

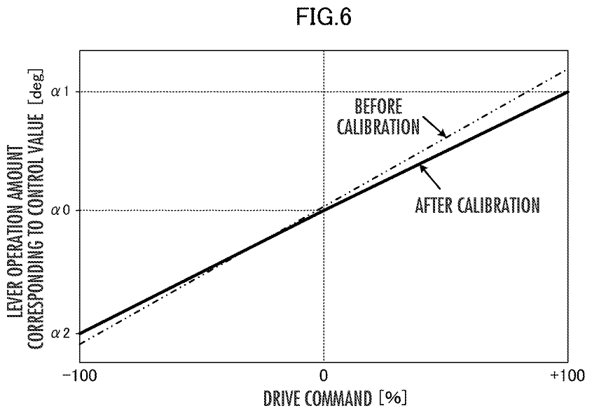

For example, as indicated by a solid graph in FIG. 6, relational data indicating a relation between a drive command and a control value is created such that a lever operation amount corresponding to a control value changes linearly with a drive command within the drive command range from 0% to +100% and within the drive command range from 0% to −100%. In this case, α0, α1, α2 denote lever operation amounts corresponding to the control values, respectively, stored and retained in STEP6, STEP11, and STEP16 in FIG. 6. Note that a chain double-dashed graph shows, as an example, a relation between a drive command and a lever operation amount which is indicated by relational data before execution of the process in the slave-side calibration mode.

As a supplementary explanation, in the present embodiment, the processes in STEP3 to STEP6 correspond to a first process according to the present invention, the processes in STEP7 to STEP11 and the processes in STEP12 to STEP16 correspond to a second process according to the present invention, and the process in STEP17 corresponds to a third process according to the present invention.

The process in the slave-side calibration mode is executed in the above-described manner for each of the slave operation levers 20 corresponding to the respective hydraulic actuators 10x of the work machine 10. After that, in a situation where remote manipulation of the work machine 10 is performed, the lever drive control unit 27a determines, from a drive command which is received from the master-side control device 50 of the remote manipulation apparatus 40, a control value for the lever drive actuator 21 on the basis of the relational data newly created in STEP17 and performs actuation control on the lever drive actuator 21 with the control value.

For the above-described reason, it is possible to drive each slave operation lever 20 into an operation status, a command for which is given by a drive command, with the lever drive actuator 21, regardless of variation in characteristics of the lever drive actuator 21 among the work machines 10 or a change in the characteristics of the lever drive actuator 21 over time resulting from, e.g., time degradation of the lever drive actuator 21. This, in turn, makes it possible to remotely manipulate the work machines 10 such that action of the hydraulic actuator 10x commensurate with operation of the operation lever 44 of the remote manipulation apparatus 40 is the same action in any work machine 10 that can be remotely manipulated by the remote manipulation apparatus 40.

The process in the slave-side calibration mode can acquire a lever drive actuator 21 control value needed to operate the slave operation lever 20 in the positive direction or the negative direction by up to the maximum operation amount for a limit of the movable range and reflect the control value in relational data by executing the processes in STEP7 and STEP8 and the processes in STEP12 and STEP13. Since the slave operation lever 20 is not rapidly displaced to the maximum operation amount, impact when the slave operation lever 20 reaches the maximum operation amount can be reduced.

A calibration process related to operation of the master operation lever 44 of the remote manipulation apparatus 40 will be described. The calibration process is a process of calibrating relational data prescribing a relation between a lever operation amount (swing angle) of the master operation lever 44 that corresponds to each hydraulic actuator 10x of the work machine 10 and is operated by an operator at the remote manipulation apparatus 40 and a drive command (a drive command to be transmitted to the slave-side control device 27 of the work machine 10 as the manipulation object) which is generated by the lever manipulation command unit 50a of the master-side control device 50 in accordance with the lever operation amount. The calibration process is executed by the lever manipulation command unit 50a of the master-side control device 50 in a manner as indicated by the flowchart in FIG. 5.

In STEP21, the lever manipulation command unit 50a of the master-side control device 50 sequentially repeats a process of judging whether there is a request for execution of a process in a master-side calibration mode until a result of the judgment is affirmative. At this time, to the master-side control device 50, a request for execution of the process in the master-side calibration mode is input when the operator performs predetermined operation of the operation device 43, for example, before the start of work by the work machine 10 or a command indicating a request for execution of the process in the master-side calibration mode is transmitted from the server 70 on an as-needed basis.

For example, the server 70 transmits a command indicating a request for execution of the process in the master-side calibration mode to the master-side control device 50 at a timing which is determined on the basis of use history information, planned use information, and the like of the remote manipulation apparatus 40. Specifically, for example, the server 70 transmits the command indicating the request for execution of the process in the master-side calibration mode to the master-side control device 50, for example, when a cumulative use time period of the remote manipulation apparatus 40 reaches a predetermined time period, when the number of times the remote manipulation apparatus 40 is used reaches a predetermined number, or at a timing before the start of work by the work machine 10 through remote manipulation of the remote manipulation apparatus 40 or a timing after the end.

When the result of the judgment in STEP21 is affirmative, the lever manipulation command unit 50a enters (turns on) the master-side calibration mode as one of operating modes of the master-side control device 50 in STEP22. The master-side calibration mode corresponds to a second calibration mode according to the present invention. The lever manipulation command unit 50a executes processes starting from STEP23 as the process in the master-side calibration mode.

As a supplementary explanation, the processes starting from STEP23 are processes to be performed for each of the operation levers 44 for manipulation of the respective hydraulic actuators 10x of the work machine 10, to be more specific. Note that only processes related to the operation lever 44 corresponding to one hydraulic actuator 10x are illustrated as a representative in FIG. 5.

In STEP23, the lever manipulation command unit 50a announces an operation request stating that the master operation lever 44 should be operated to the neutral position to the operator. The announcement can be made via, for example, both or one of the speaker 45 and the display 46 of the remote manipulation apparatus 40 or a portable terminal carried by the operator.

In STEP24, the lever manipulation command unit 50a sequentially repeats a process of judging whether operation of the master operation lever 44 to the neutral position is complete until a result of the judgment is affirmative. The judgment can be made on the basis of, for example, whether predetermined operation (operation at the operation device 43) indicating completion of operation of the master operation lever 44 is performed by the operator. The judgment process in STEP24 can also be performed on the basis of, for example, a change in a detection value of an operation amount (swing angle) of the master operation lever 44 which is detected by the lever operation amount detector 49.

When the result of the judgment in STEP24 is affirmative, the lever manipulation command unit 50a stores and retains, as a value of the lever operation amount of the master operation lever 44 which corresponds to a drive command of 0%, a current detection value (a detection value at a time point of judgment of the result of the judgment in STEP24 as affirmative) of the lever operation amount in STEP25.

In STEP26, the lever manipulation command unit 50a announces an operation request stating that the master operation lever 44 should be operated to a maximum operation position in a positive direction to the operator. The announcement is made in the same manner as in STEP23.

In STEP27, the lever manipulation command unit 50a sequentially repeats a process of judging whether operation of the master operation lever 44 to the maximum operation position in the positive direction is complete until a result of the judgment is affirmative. The judgment is made in the same manner as in STEP24.

When the result of the judgment in STEP27 is affirmative, the lever manipulation command unit 50a stores and retains, as a value of the lever operation amount of the master operation lever 44 which corresponds to a drive command of +100%, the current detection value (a detection value at a time point of judgment of the result of the judgment in STEP27 as affirmative) of the lever operation amount in STEP28.

In STEP29, the lever manipulation command unit 50a announces an operation request stating that the master operation lever 44 should be operated to a maximum operation position in a negative direction to the operator. The announcement is made in the same manner as in STEP23.

In STEP30, the lever manipulation command unit 50a sequentially repeats a process of judging whether operation of the master operation lever 44 to the maximum operation position in the negative direction is complete until a result of the judgment is affirmative. The judgment is made in the same manner as in STEP24.

When a result of the judgment in STEP30 is affirmative, the lever manipulation command unit 50a stores and retains, as a value of the lever operation amount of the master operation lever 44 which corresponds to a drive command of −100%, the current detection value (a detection value at a time point of judgment of the result of the judgment in STEP30 as affirmative) of the lever operation amount in STEP31.

In STEP32, the lever manipulation command unit 50a creates relational data prescribing a relation between the lever operation amount of the master operation lever 44 and a drive command and stores and retains the relational data. The relational data is expressed in the form of, for example, an arithmetic expression or a map.

In the above-described case, relational data prescribing a relation between a lever operation amount and a drive command is created using, as constraints, the lever operation amount corresponding to the drive command of 0%, the lever operation amount corresponding to the drive command of +100%, and the lever operation amount corresponding to the drive command of −100% that are stored in STEP25, STEP28, and STEP31, respectively, such that a drive command changes linearly with a change in the lever operation amount (swing angle) of the master operation lever 44 within a drive command range from 0% to +100% and within a drive command range from 0% to −100% and is stored and retained.

In the case, the relational data is created such that a drive command corresponding to the detection value of the lever operation amount stored and retained in STEP25, a drive command corresponding to the detection value of the lever operation amount stored and retained in STEP28, and a drive command corresponding to the detection value of the lever operation amount stored and retained in STEP31 are the drive command of 0%, the drive command of +100%, and the drive command of −100%, respectively.

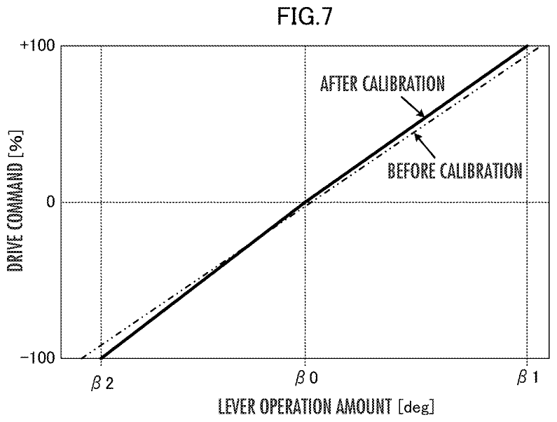

For example, as indicated by a solid graph in FIG. 7, relational data prescribing a relation between a lever operation amount and a drive command is created such that a drive command changes linearly with a change in a lever operation amount (swing angle) within the drive command range from 0% to +100% and within the drive command range from 0% to −100%. In this case, β0, β1, and β2 denote the values, respectively, of the lever operation amounts stored and retained in STEP25, STEP28, and STEP31 in FIG. 7. Note that a chain double-dashed graph shows, as an example, a relation between a lever operation amount and a drive command which is indicated by relational data before execution of the process in the master-side calibration mode.

As a supplementary explanation, in the present embodiment, the processes in STEP23 to STEP25 correspond to an A-th process according to the present invention, the processes in STEP26 to STEP28 and the processes in STEP29 to STEP31 correspond to a B-th process according to the present invention, and the process in STEP32 corresponds to a C-th process according to the present invention.

The process in the master-side calibration mode is executed in the above-described manner for each of the master operation levers 44 for manipulation of the respective hydraulic actuators 10x of the work machine 10. After that, in a situation where remote manipulation of the work machine 10 is performed by the remote manipulation apparatus 40, the lever manipulation command unit 50a determines, from a detection value of a lever operation amount of the master operation lever 44, a drive command to be transmitted to the slave-side control device 27 of the work machine 10 on the basis of the relational data newly created in STEP31.

For the above-described reason, it is possible to generate, with high reliability, a required drive command in accordance with operation of the master operation lever 44 (i.e., in accordance with a request from the operator) with the lever manipulation command unit 50a, regardless of variation in operation characteristics of the master operation lever 44 among the remote manipulation apparatuses 40, variation in characteristics of the lever operation amount detector 49, a change in the operation characteristics of the master operation lever 44 resulting from, e.g., time degradation of an operation mechanism of the master operation lever 44, or the like and transmit the drive command to the slave-side control device 27 of the work machine 10 as the manipulation object. This, in turn, makes it possible to appropriately reflect an intention of the operator indicated by operation of the master operation lever 44 and perform remote manipulation of the work machine 10.

### Second Embodiment

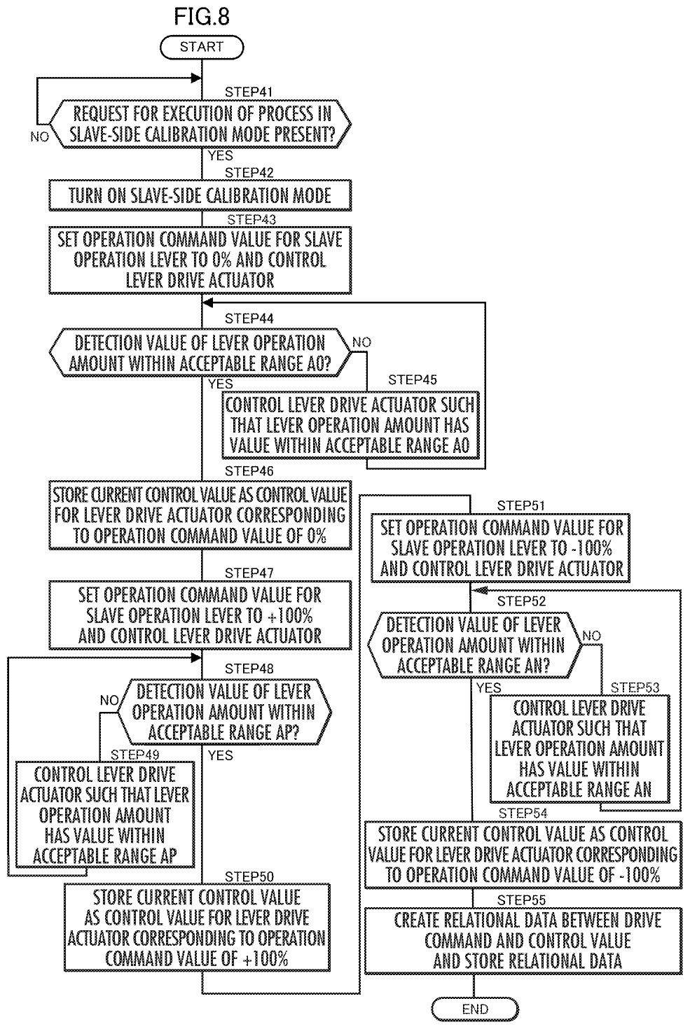

A second embodiment of the present invention will be described with reference to FIG. 8. Note that the present embodiment is different from the first embodiment only in that a process in a slave-side calibration mode. Thus, a description of matters identical to those in the first embodiment will be omitted.

In the present embodiment, the process in the slave-side calibration mode is executed by a lever drive control unit 27a of a slave-side control device 27 in a manner as indicated by a flowchart in FIG. 8. From STEP41 to STEP46, the same processes as in STEP1 to STEP6 in the first embodiment are executed by the lever drive control unit 27a. With this execution, a control value for a lever drive actuator 21 corresponding to a drive command of 0% is identified and is stored and retained.

In STEP47, the lever drive control unit 27a sets a drive command for a slave operation lever 20 to +100% (a drive command for operation of the slave operation lever 20 to a maximum operation position in a positive direction) and controls the lever drive actuator 21 in accordance with the drive command. In this case, the lever drive control unit 27a determines a control value for the lever drive actuator 21 corresponding to the drive command of +100% on the basis of relational data (relational data created by the process in the slave-side calibration mode on the previous occasion or default relational data) which has already been stored and retained in the slave-side control device 27 and actuates the lever drive actuator 21 with the control value, as in STEP43.

In STEP48, the lever drive control unit 27a acquires a detection value of a lever operation amount (swing angle) of the slave operation lever 20 from a lever operation amount detector 23 and judges whether the detection value falls within a predetermined acceptable range AP. The acceptable range AP is a range which is determined in advance as a proper range for a lever operation amount which is detected by the lever operation amount detector 23 when a drive command for the slave operation lever 20 is +100%.

In other words, the acceptable range AP is a range which is set so as to satisfy the condition that a difference between a value of a lever operation amount within the acceptable range AP and a proper reference value for a maximum lever operation amount in the positive direction when the drive command is +100% falls within a predetermined range and is set in advance, for example, for each of models of work machines 10 or for each individual work machine 10.

If a result of the judgment in STEP48 is negative, the lever drive control unit 27a controls the lever drive actuator 21 such that the lever operation amount of the slave operation lever 20 has a value within the acceptable range AP in STEP49 and further executes the judgment process in STEP48 again.

In STEP49, the lever drive control unit 27a, for example, updates a control value for the lever drive actuator 21 by a predetermined amount such that the lever operation amount of the slave operation lever 20 is closer to within the acceptable range AP and actuates the lever drive actuator 21 in accordance with the updated control value.

Alternatively, the lever drive control unit 27a updates the control value for the lever drive actuator 21 by a correction value which is determined in accordance with a deviation of a detection value of the lever operation amount of the slave operation lever 20 from a representative value (e.g., a value of one closer to the detection value of the lever operation amount of an upper limit and a lower limit of the acceptable range AP or a median of the acceptable range AP) of the acceptable range AP and actuates the lever drive actuator 21 with the updated control value.

If the result of the judgment in STEP48 is affirmative, the lever drive control unit 27a stores and retains the current control value (a control value at a time point of judgment of the result of the judgment in STEP48 as affirmative) as the control value for the lever drive actuator 21 corresponding to the drive command of +100% in STEP50.

In STEP51, the lever drive control unit 27a sets the drive command for the slave operation lever 20 to −100% (a drive command for operation of the slave operation lever 20 to a maximum operation position in a negative direction) and controls the lever drive actuator 21 in accordance with the drive command. In this case, the lever drive control unit 27a determines a control value for the lever drive actuator 21 corresponding to the drive command of −100% on the basis of the relational data (relational data created by the process in the slave-side calibration mode on the previous occasion or default relational data) that has already been stored and retained in the slave-side control device 27 and actuates the lever drive actuator 21 with the control value, as in STEP43.

In STEP52, the lever drive control unit 27a acquires a detection value of the lever operation amount (swing angle) of the slave operation lever 20 from the lever operation amount detector 23 and judges whether the detection value falls within a predetermined acceptable range AN.

The acceptable range AN is a range which is determined in advance as a proper range for a lever operation amount which is detected by the lever operation amount detector 23 when a drive command for the slave operation lever 20 is −100%. In other words, the acceptable range AN is a range which is set so as to satisfy the condition that a difference between a value of a lever operation amount within the acceptable range AN and an appropriate reference value for a maximum lever operation amount in the negative direction when the drive command is −100% falls within a predetermined range and is set in advance, for example, for each of the models of the work machines 10 or for each individual work machine 10.

If a result of the judgment in STEP52 is negative, the lever drive control unit 27a controls the lever drive actuator 21 such that the lever operation amount of the slave operation lever 20 has a value within the acceptable range AN in STEP53 and further executes the judgment process in STEP52 again.

In STEP53, the lever drive control unit 27a, for example, updates the control value for the lever drive actuator 21 by a predetermined amount such that the lever operation amount of the slave operation lever 20 is closer to within the acceptable range AN and actuates the lever drive actuator 21 in accordance with the updated control value.

Alternatively, the lever drive control unit 27a updates the control value for the lever drive actuator 21 by a correction amount which is determined in accordance with a deviation of a detection value of the lever operation amount of the slave operation lever 20 from a representative value (e.g., a value of one closer to the detection value of the lever operation amount of an upper limit and a lower limit of the acceptable range AN or a median of the acceptable range AN) of the acceptable range AN and actuates the lever drive actuator 21 with the updated control value.

If the result of the judgment in STEP52 is affirmative, the lever drive control unit 27a stores and retains the current control value (a control value at a time point of judgment of the result of the judgment in STEP52 as affirmative) as the control value for the lever drive actuator 21 corresponding to the drive command of −100% in STEP54.

In STEP55, the lever drive control unit 27a creates relational data (relational data expressed as, for example, an arithmetic expression or a map) prescribing a relation between a drive command and a control value for the lever drive actuator 21 and stores and retains the relational data. In this case, relational data prescribing a relation between a drive command and a control value is created using, as constraints, the control value corresponding to the drive command of 0%, the control value corresponding to the drive command of +100%, and the control value corresponding to the drive command of −100% that are stored in STEP46, STEP50, and STEP54, respectively, such that a lever operation amount (swing angle) of the slave operation lever 20 which is obtained by actuating the lever drive actuator 21 in accordance with a control value changes linearly with a drive command within a drive command range from 0% to +100% and within a drive command range from 0% to −100%, as in the first embodiment (as shown as an example by, for example, the solid graph in FIG. 6) and is stored and retained.

In the above-described case, the relational data is created such that a control value which is prescribed by new relational data so as to correspond to the drive command of 0% coincides with the control value stored in STEP46, such that a control value which is prescribed by the new relational data so as to correspond to the drive command of +100% coincides with the control value stored in STEP50, and such that a control value which is prescribed by the new relational data so as to correspond to the drive command of −100% coincides with the control value stored in STEP54.

As a supplementary explanation, in the present embodiment, the processes in STEP43 to STEP46 correspond to a first process according to the present invention, the processes in STEP47 to STEP50 and the processes in STEP51 to STEP54 correspond to a second process according to the present invention, and the process in STEP55 corresponds to a third process according to the present invention.

In the present embodiment, the process in the slave-side calibration mode is executed in the above-described manner for each of the slave operation levers 20 corresponding to the respective hydraulic actuators 10x of the work machine 10. The present embodiment is the same as the first embodiment except for the above-described matters.

According to the present embodiment, it is possible to drive each slave operation lever 20 into an operation status, a command for which is given by a drive command, with the lever drive actuator 21, regardless of variation in characteristics of the lever drive actuator 21 among the work machines 10 or a change in the characteristics of the lever drive actuator 21 over time resulting from, e.g., time degradation of the lever drive actuator 21, as in the first embodiment. This, in turn, makes it possible to remotely manipulate the work machines 10 such that action of the hydraulic actuator 10x commensurate with operation of the operation lever 44 of the remote manipulation apparatus 40 is the same action in any work machine 10 that can be remotely manipulated by the remote manipulation apparatus 40.

The present embodiment can keep a swing range of the slave operation lever 20 in a drive command range from +100% to −100% within a mechanistically movable range of the slave operation lever 20. For this reason, it is possible to prevent the slave operation lever 20 from being operated to a limit of the movable range and in turn to prevent occurrence of a situation where large force of impact acts on the slave operation lever 20.

### Other Embodiments

Note that the present invention is not limited to the above-described first embodiment or second embodiment and that any other embodiment can also be adopted. For example, as for the process in the slave-side calibration mode, the order of execution of the processes in STEP7 to STEP11 and the processes in STEP12 to STEP16 shown in FIG. 4 may be made opposite to that in the first embodiment or the order of execution of the processes in STEP47 to STEP50 and the processes in STEP51 to STEP54 shown in FIG. 8 may be made opposite to that in the second embodiment.

As for the process in the master-side calibration mode, the order of execution of the processes in STEP23 to STEP25, the processes in STEP26 to STEP28, and the processes in STEP29 to STEP31 shown in FIG. 5 may be made different from those in the embodiments.

Although a hydraulic shovel is shown as an example of the work machine 10 in each embodiment, a work machine according to the present invention is not limited to a hydraulic shovel and may be any other type of work machine, such as a crane.

As has been described above, a hydraulic work machine of the present invention is a hydraulic work machine including a hydraulic actuator, a first operation lever for operating the hydraulic actuator, a lever drive actuator which drives the first operation lever, and a lever drive control unit which is capable of receiving a drive command for operation of the first operation lever from an external manipulation apparatus and performs actuation control on the lever drive actuator in accordance with the drive command,

wherein the lever drive control unit

is capable of acquiring a detection value of an operation amount of the first operation lever detected by a first lever operation amount detector which is mounted on the hydraulic work machine so as to be capable of detecting the operation amount of the first operation lever and has a first calibration mode which is an operating mode for performing calibration related to remote manipulation of the first operation lever,

has a function of, when an execution command for a process in the first calibration mode is given, executing a first process of controlling the lever drive actuator so as to achieve a state satisfying a first condition that the detection value of the operation amount of the first operation lever falls within a predetermined range determined in advance for a neutral position of the first operation lever and storing and retaining a control value for the lever drive actuator in the state satisfying the first condition while actuation of the hydraulic actuator is prohibited, a second process of controlling the lever drive actuator so as to achieve a state satisfying a second condition that the detection value of the operation amount of the first operation lever coincides with a maximum operation amount for the first operation lever or a difference from the maximum operation amount falls within a predetermined range and storing and retaining a control value for the lever drive actuator in the state satisfying the second condition while actuation of the hydraulic actuator is prohibited, and a third process of determining data prescribing a relation between the drive command and a control value for controlling the lever drive actuator in accordance with the drive command on the basis of the control values stored and retained in the first process and the second process, respectively, and storing and retaining the data and is configured to determine the data in the third process such that the control value prescribed in the data coincides with the control value stored in the first process if the drive command is a drive command giving a command for operation of the first operation lever to the neutral position and such that the control value prescribed in the data coincides with the control value stored in the second process if the drive command is a drive command giving a command for operation of the first operation lever to the maximum operation amount for the first operation lever, and

is configured to, at the time of actuation of the lever drive actuator in accordance with a drive command received from the manipulation apparatus after execution of the third process, perform actuation control on the lever drive actuator with the control value determined from the received drive command on the basis of the data stored and retained in the third process (a first invention).

Note that, in the present invention, an operation lever (the first operation lever or a second operation lever (to be described later)) is not limited to an operation unit with which a manipulator performs manual operation and may be an operation unit (e.g., a pedal-type operation unit) which a manipulator operates with a foot.

According to the first invention, since the lever drive control unit of the hydraulic work machine executes the first to third processes when the execution command for the process in the first calibration mode is given, the data prescribing the relation between the drive command and the control value for controlling the lever drive actuator in accordance with the drive command can be determined according to characteristics of actual driving of the first operation lever by the lever drive actuator.

Specifically, it is possible to determine the data such that the control value prescribed in the data coincides with the control value stored in the first process if the drive command is the drive command giving the command for operation of the first operation lever to the neutral position and such that the control value prescribed in the data coincides with the control value stored in the second process if the drive command is the drive command giving a command for operation of the first operation lever to the maximum operation amount. This, in turn, makes it possible to determine the data such that an operation status of the first operation lever commensurate with the drive command can be prevented from varying in accordance with the hydraulic work machine as a remote manipulation object.

The first process and the second process that perform a process of driving the first operation lever with the lever drive actuator of the process in the first calibration mode are executed while actuation of the hydraulic actuator is prohibited. It is thus possible to drive the first operation lever without actuating the hydraulic actuator.

At the time of actuation of the lever drive actuator in accordance with a drive command received from a lever manipulation command unit after execution of the third process, the lever drive control unit performs actuation control on the lever drive actuator with the control value determined from the received drive command and the data stored and retained in the third process. This makes it possible to appropriately prevent the operation status of the first operation lever of the hydraulic work machine that is achieved in accordance with operation of the manipulation apparatus from varying. For example, it is possible to appropriately implement operating the first operation lever of the hydraulic work machine to the neutral position or operating the first operation lever to the maximum operation amount through operation of the manipulation apparatus, regardless of hydraulic work machine as a remote manipulation object.

The first invention can adopt an aspect in which the lever drive control unit is configured to, in the second process, control the lever drive actuator so as to gradually increase the operation amount of the first operation lever until the detection value of the operation amount of the first operation lever no longer increases and store and retain, as the control value in the state satisfying the second condition, a control value for the lever drive actuator in a state where the detection value of the operation amount of the first operation lever no longer increases (a second invention).

According to the above-described aspect, it is possible to, in the second process, reliably drive the first operation lever by up to the maximum operation amount and acquire a control value for the lever drive actuator needed for operation of the first operation lever by the maximum operation amount even if the maximum operation amount for the first operation lever is not known. Since the first operation lever is not rapidly displaced to the maximum operation amount, impact when the first operation lever reaches the maximum operation amount can be reduced.

The second invention can adopt an aspect in which a pressure detector which detects a pilot pressure given to a directional control valve for supply of hydraulic oil to the hydraulic actuator in accordance with the operation amount of the first operation lever is provided, and the lever drive control unit is capable of acquiring a detection value of the pilot pressure detected by the pressure detector and is configured to, if the detection value of the pilot pressure in the state where the detection value of the operation amount of the first operation lever no longer increases is less than a predetermined value in the second process, produce alarm output stating that the detection value of the pilot pressure is less than the predetermined value (a third invention).

According to the above-described aspect, it is possible to announce, through the alarm output, that even if the first operation lever of the hydraulic work machine is operated by the maximum operation amount, the pilot pressure given to the directional control valve for supply of the hydraulic oil to the hydraulic actuator cannot be made sufficiently high, which may in turn make an actuation speed of the hydraulic actuator insufficient.

A remote manipulation system of the present invention includes the hydraulic work machines of the first to third inventions and the above-described manipulation apparatus (a fourth invention).

According to the above-described aspect, it is possible to construct, through the remote manipulation system including the hydraulic work machine, a remote manipulation system capable of performing appropriate work, regardless of hydraulic work machine.

The fourth invention can adopt an aspect in which the manipulation apparatus is configured to have a function of transmitting the execution command for the process in the first calibration mode to the lever drive control unit of the hydraulic work machine, and the lever drive control unit of the hydraulic work machine is configured to execute the process in the first calibration mode in response to reception of the execution command (a fifth invention).

According to the above-described aspect, it is possible to give a command to execute the process in the first calibration mode from the manipulation apparatus to lever drive control units of a plurality of hydraulic work machines without the need for operation at each hydraulic work machine.

The fourth invention or the fifth invention can adopt an aspect in which the manipulation apparatus is a manipulation apparatus including a second operation lever for remote manipulation of the first operation lever, a second lever operation amount detector which is capable of detecting an operation amount of the second operation lever, and a lever manipulation command unit which generates the drive command in accordance with a detection value of the operation amount of the second operation lever from the second lever operation amount detector and transmits the drive command to the hydraulic work machine, and

the lever manipulation command unit has a second calibration mode which is an operating mode for performing calibration related to operation of the second operation lever, further has a function of, when execution of a process in the second calibration mode is commanded, executing an A-th process of acquiring the detection value of the operation amount of the second operation lever and storing and retaining the detection value while the second operation lever is operated to a neutral position, a B-th process of acquiring the detection value of the operation amount of the second operation lever and storing and retaining the detection value while the second operation lever is operated by a maximum operation amount, and a C-th process of determining second data prescribing a relation between the operation amount of the second operation lever and the drive command such that the drive command corresponding to the detection value of the operation amount of the second operation lever stored and retained in the A-th process is a drive command for operating the first operation lever to the neutral position and such that the drive command corresponding to the detection value of the operation amount of the second operation lever stored and retained in the B-th process is a drive command for operating the first operation lever by the maximum operation amount and storing and retaining the second data, and is configured to, at the time of transmission of the drive command to the hydraulic work machine in accordance with operation of the second operation lever after execution of the C-th process, transmit, to the lever manipulation command unit, a drive command determined from the detection value of the operation amount of the second operation lever on the basis of the second data stored and retained in the C-th process (a sixth invention).

According to the above-described aspect, it is possible to implement transmitting a drive command commensurate with the operation amount of the second operation lever to the lever drive control unit of the hydraulic work machine such that a drive command to be transmitted to the lever drive control unit of the hydraulic work machine when the second operation lever of the manipulation apparatus is operated to the neutral position is the drive command for operating the first operation lever to the neutral position and such that a drive command to be transmitted to the lever drive control unit of the hydraulic work machine when the second operation lever is operated by the maximum operation amount is the drive command for operating the first operation lever by the maximum operation amount, regardless of variation in operation characteristics of the second operation lever or detection characteristics of the second lever operation amount detector of the manipulation apparatus. This, in turn, makes it possible to enhance consistency of operation of the first operation lever of the hydraulic work machine with operation of the second operation lever of the manipulation apparatus.

The sixth invention can adopt an aspect further including a first server which is capable of communication with the manipulation apparatus and has a function of transmitting, to the manipulation apparatus, a command to cause an announcement information output unit which is provided at the manipulation apparatus to output announcement information stating that the process in the second calibration mode is to be executed (a seventh invention).

According to the above-described aspect, since it is possible for the manipulation apparatus including the second operation lever to output the announcement information stating that the process in the second calibration mode is to be executed on an as-needed basis, execution of the process in the second calibration mode can be promoted on an as-needed basis.

The seventh invention can adopt an aspect in which the first server is configured to transmit the command to cause output of the announcement information to the manipulation apparatus at a timing which is determined on the basis of at least one piece of information of use history information and planned use information of the manipulation apparatus (an eighth invention).

According to the above-described aspect, it is possible to output, at the manipulation apparatus, the announcement information stating that the process in the second calibration mode is to be executed at an appropriate timing with the use history information or the planned use information of the manipulation apparatus in mind.

The fourth to eighth inventions can adopt an aspect further including a second server which is capable of communication with the lever drive control unit of the hydraulic work machine and has a function of transmitting the execution command for the process in the first calibration mode to the lever drive control unit (a ninth invention).

According to the above-described aspect, it is possible to execute the process in the first calibration mode at a hydraulic work machine not used in actual work on an as-needed basis without the need for operation of the manipulation apparatus.

The ninth invention can adopt an aspect in which the second server is configured to transmit the execution command for the process in the first calibration mode to the lever drive control unit of the hydraulic work machine at a timing which is determined on the basis of at least one piece of information of work history information and planned work information of the hydraulic work machine (a tenth invention).

According to the above-described aspect, it is possible to execute the process in the first calibration mode at the hydraulic work machine at an appropriate timing with the work history information or the planned work information of the hydraulic work machine in mind.

1. A hydraulic work machine comprising a hydraulic actuator, a first operation lever for operating the hydraulic actuator, a lever drive actuator which drives the first operation lever, and a lever drive control unit which is capable of receiving a drive command for operation of the first operation lever from an external manipulation apparatus and performs actuation control on the lever drive actuator in accordance with the drive command,
wherein the lever drive control unit
is configured to be capable of acquiring a detection value of an operation amount of the first operation lever detected by a first lever operation amount detector which is mounted on the hydraulic work machine so as to be capable of detecting the operation amount of the first operation lever and to have a first calibration mode which is an operating mode for performing calibration related to remote manipulation of the first operation lever,
is configured to have a function of, when an execution command for a process in the first calibration mode is given, executing a first process of controlling the lever drive actuator so as to achieve a state satisfying a first condition that the detection value of the operation amount of the first operation lever falls within a predetermined range determined in advance for a neutral position of the first operation lever and storing and retaining a control value for the lever drive actuator in the state satisfying the first condition while actuation of the hydraulic actuator is prohibited, a second process of controlling the lever drive actuator so as to achieve a state satisfying a second condition that the detection value of the operation amount of the first operation lever coincides with a maximum operation amount for the first operation lever or a difference from the maximum operation amount falls within a predetermined range and storing and retaining a control value for the lever drive actuator in the state satisfying the second condition while actuation of the hydraulic actuator is prohibited, and a third process of determining data prescribing a relation between the drive command and a control value for controlling the lever drive actuator in accordance with the drive command based on the control values stored and retained in the first process and the second process, respectively, and storing and retaining the data, and is configured to determine the data in the third process such that the control value prescribed in the data coincides with the control value stored in the first process if the drive command is a drive command giving a command for operation of the first operation lever to the neutral position and such that the control value prescribed in the data coincides with the control value stored in the second process if the drive command is a drive command giving a command for operation of the first operation lever to the maximum operation amount for the first operation lever, and
is configured to, at a time of actuation of the lever drive actuator in accordance with a drive command received from the manipulation apparatus after execution of the third process, perform actuation control on the lever drive actuator with the control value determined from the received drive command based on the data stored and retained in the third process.

2. The hydraulic work machine according to claim 1, wherein
the lever drive control unit is configured to, in the second process, control the lever drive actuator so as to gradually increase the operation amount of the first operation lever until the detection value of the operation amount of the first operation lever no longer increases and store and retain, as the control value in the state satisfying the second condition, a control value for the lever drive actuator in a state where the detection value of the operation amount of the first operation lever no longer increases.

3. The hydraulic work machine according to claim 2, further comprising
a pressure detector which detects a pilot pressure given to a directional control valve for supply of hydraulic oil to the hydraulic actuator in accordance with the operation amount of the first operation lever is provided, wherein
the lever drive control unit is configured to be capable of acquiring a detection value of the pilot pressure detected by the pressure detector and is configured to, if the detection value of the pilot pressure in the state where the detection value of the operation amount of the first operation lever no longer increases is less than a predetermined value in the second process, produce alarm output stating that the detection value of the pilot pressure is less than the predetermined value.

4. A remote manipulation system comprising the hydraulic work machine according to claim 1 and the manipulation apparatus.

5. The remote manipulation system according to claim 4, wherein
the manipulation apparatus is configured to have a function of transmitting the execution command for the process in the first calibration mode to the lever drive control unit of the hydraulic work machine, and the lever drive control unit of the hydraulic work machine is configured to execute the process in the first calibration mode in response to reception of the execution command.

6. The remote manipulation system according to claim 4, wherein
the manipulation apparatus is a manipulation apparatus including a second operation lever for remote manipulation of the first operation lever, a second lever operation amount detector which is capable of detecting an operation amount of the second operation lever, and a lever manipulation command unit which generates the drive command in accordance with a detection value of the operation amount of the second operation lever from the second lever operation amount detector and transmits the drive command to the hydraulic work machine, and
the lever manipulation command unit has a second calibration mode which is an operating mode for performing calibration related to operation of the second operation lever, further configured to have a function of, when execution of a process in the second calibration mode is commanded, executing an A-th process of acquiring the detection value of the operation amount of the second operation lever and storing and retaining the detection value while the second operation lever is operated to a neutral position, a B-th process of acquiring the detection value of the operation amount of the second operation lever and storing and retaining the detection value while the second operation lever is operated by a maximum operation amount, and a C-th process of determining second data prescribing a relation between the operation amount of the second operation lever and the drive command such that the drive command corresponding to the detection value of the operation amount of the second operation lever stored and retained in the A-th process is a drive command for operating the first operation lever to the neutral position and such that the drive command corresponding to the detection value of the operation amount of the second operation lever stored and retained in the B-th process is a drive command for operating the first operation lever by the maximum operation amount, and storing and retaining the second data, and
is configured to, at a time of transmission of the drive command to the hydraulic work machine in accordance with operation of the second operation lever after execution of the C-th process, transmit, to the lever manipulation command unit, a drive command determined from the detection value of the operation amount of the second operation lever based on the second data stored and retained in the C-th process.

7. The remote manipulation system according to claim 6, further comprising
a first server which is capable of communication with the manipulation apparatus and is configured to have a function of transmitting, to the manipulation apparatus, a command to cause an announcement information output unit which is provided at the manipulation apparatus to output announcement information that the process in the second calibration mode is to be executed.

8. The remote manipulation system according to claim 7, wherein
the first server is configured to transmit the command to cause output of the announcement information to the manipulation apparatus at a timing which is determined based on at least one piece of information of use history information and planned use information of the manipulation apparatus.

9. The remote manipulation system according to claim 4, further comprising
a second server which is capable of communication with the lever drive control unit of the hydraulic work machine and is configured to have a function of transmitting the execution command for the process in the first calibration mode to the lever drive control unit.

10. The remote manipulation system according to claim 9, wherein
the second server is configured to transmit the execution command for the process in the first calibration mode to the lever drive control unit of the hydraulic work machine at a timing which is determined based on at least one piece of information of work history information and planned work information of the hydraulic work machine.
